(19) United States
(12) Patent Application Publication
(10) Pub. No.: US 2013/0070855 A1
(43) Pub. Date: Mar. 21, 2013

(54) HYBRID MOTION VECTOR CODING MODES FOR VIDEO CODING

(71) Applicants: Yunfei Zheng, Cupertino, CA (US); Xianglin Wang, San Diego, CA (US); Marta Karczewicz, San Diego, CA (US)

(72) Inventors: Yunfei Zheng, Cupertino, CA (US); Xianglin Wang, San Diego, CA (US); Marta Karczewicz, San Diego, CA (US)

(73) Assignee: QUALCOMM INCORPORATED, San Diego, CA (US)

(21) Appl. No.: 13/614,018

(22) Filed: Sep. 13, 2012

Related U.S. Application Data
(60) Provisional application No. 61/535,963, filed on Sep. 17, 2011.

(51) Int. Cl. H04N 7/32

(52) U.S. Cl. 375/240.16; 375/E07.125

(57) ABSTRACT

In one example, a device for coding video data includes a video coder (such as a video decoder or a video encoder) configured to code motion information for a current block of video data using a hybrid motion information coding mode, wherein to code the motion information, the video coder is configured to code a merge index syntax element of the motion information in a manner substantially conforming to a merge mode, and code at least one additional syntax element of the motion information in a manner substantially conforming to an advanced motion vector prediction (AMVP) mode, and wherein the video coder is configured to code the current block using the motion information. The hybrid mode may comprise a partial merge mode or a partial AMVP mode.

This application claims the benefit of U.S. Provisional Application No. 61/535,963, filed Sep. 17, 2011, which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference pictures.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding motion information using a hybrid mode. Motion information may include, for example, a merge index, an inter-prediction direction, a reference index, an advance motion vector prediction (AMVP) index, and a motion vector difference. In merge mode of the upcoming High Efficiency Video Coding (HEVC) standard, a merge index is coded for a prediction unit (PU) to indicate the location of a candidate inside a merge candidate list from which other motion information is inherited. In AMVP mode of the upcoming HEVC standard, the inter-prediction direction, reference index, AMVP index, and MVD are explicitly coded for a PU. This disclosure describes various hybrid modes for coding motion information, where the hybrid modes may code some motion information in a manner similar to merge mode, and other motion information in a manner similar to AMVP mode.

In one example, a method includes coding motion information for a current block of video data using a hybrid motion information coding mode, wherein coding the motion information comprises coding a merge index syntax element of the motion information in a manner substantially conforming to a merge mode, and coding at least one additional syntax element of the motion information in a manner substantially conforming to an advanced motion vector prediction (AMVP) mode, and coding the current block using the motion information.

In another example, a device includes a video coder configured to code motion information for a current block of video data using a hybrid motion information coding mode, wherein to code the motion information, the video coder is configured to code a merge index syntax element of the motion information in a manner substantially conforming to a merge mode, and code at least one additional syntax element of the motion information in a manner substantially conforming to an advanced motion vector prediction (AMVP) mode, and wherein the video coder is configured to code the current block using the motion information.

In another example, a device includes means for coding motion information for a current block of video data using a hybrid motion information coding mode, wherein coding the motion information comprises means for coding a merge index syntax element of the motion information in a manner substantially conforming to a merge mode, and means for coding at least one additional syntax element of the motion information in a manner substantially conforming to an advanced motion vector prediction (AMVP) mode, and means for coding the current block using the motion information.

In another example, a computer-readable storage medium has stored thereon instructions that, when executed, cause a processor to code motion information for a current block of video data using a hybrid motion information coding mode, wherein the instructions that cause the processor to code the motion information comprise instructions that cause the processor to code a merge index syntax element of the motion information in a manner substantially conforming to a merge mode, and code at least one additional syntax element of the motion information in a manner substantially conforming to an advanced motion vector prediction (AMVP) mode, and code the current block using the motion information.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for coding motion information using a hybrid mode.

FIG. 2 is a block diagram illustrating an example of a video encoder that may implement techniques for coding motion information using a hybrid mode.

FIG. 3 is a block diagram illustrating an example of a video decoder that may implement techniques for coding motion information using a hybrid mode.

FIG. 4 is a conceptual diagram illustrating example merge candidates for a current block.

FIG. 5 is a conceptual diagram illustrating an example current block including a motion vector that is coded using a partial merge mode.

FIG. 6 is a conceptual diagram illustrating an example current block including motion information that is coded using a partial Advanced Motion Vector Prediction (AMVP) mode.

FIG. 7 is a conceptual diagram illustrating another example current block that includes motion information coded using partial AMVP mode.

FIG. 8 is a conceptual diagram illustrating another example current block that includes motion information coded using partial AMVP mode.

FIG. 9 is a flowchart illustrating an example method for encoding a current block and encoding motion information for the current block.

FIG. 10 is a flowchart illustrating an example method for decoding motion information for a current block of video data, and for decoding the current block using the motion information.

FIG. 11 is a flowchart illustrating an example method for determining a motion information coding mode when one hybrid mode is available in addition to merge mode and AMVP mode.

FIG. 12 is a flowchart illustrating another example method for determining a motion information coding mode when one hybrid mode is available in addition to merge mode and AMVP mode.

FIG. 13 is a flowchart illustrating an example method for determining a motion information coding mode when two hybrid modes are available in addition to merge mode and AMVP mode.

### DETAILED DESCRIPTION

In general, this disclosure describes techniques related to coding of motion information for inter-prediction coding of blocks of video data. Video coders may code video data using inter-prediction modes, which take advantage of temporal redundancy. In particular, a video coder may use a motion vector to code a current block of video data, where the motion vector indicates the location of a predictive block to use to code the current block.

Motion information defining the motion vector may include an inter-prediction direction syntax element, a merge index syntax element, a reference index syntax element, an advanced motion vector prediction (AMVP) index syntax element, and motion vector difference (MVD) syntax elements. The inter-prediction direction syntax element may describe whether the motion vector points forward or backward in time (that is, to a picture that has a display order later or earlier than the display order of the current picture being coded). The merge index syntax element may indicate the location of reference motion information, from which other motion information may be inherited. The reference index syntax element may correspond to an index into a list of potential reference pictures. The AMVP index may indicate which of a plurality of neighboring blocks from which to select a motion vector as motion vector predictor for AMVP. The MVD syntax elements may define differences between horizontal and/or vertical components of an actual motion vector and a motion vector predictor for a current block of video data.

In the upcoming High Efficiency Video Coding (HEVC) standard, there are two ways of coding motion information. In the first, referred to as merge mode, all motion information for a current block is inherited from a candidate in the merge candidate list, which is indicated using the merge index (e.g., a left neighboring block or an upper neighboring block). In the second, referred to as AMVP mode, nearly all motion information is explicitly signaled, including MVD values that describe horizontal and/or vertical offsets relative to components of a motion vector predictor indicated by an AMVP index value.

Thus, the current motion information coding modes may be summarized as shown in Table 1 below, where an “x” in a box indicates that the information described along the horizontal axis is signaled for the corresponding mode indicated by the vertical axis:

TABLE 1

| | | | Reference | | |
|---|---|---|---|---|---|
| Mode | InterDir | Merge Index | Index | AMVP Index | MVD |
| Merge | | x | | | |
| AMVP | x | | x | x | x |

This disclosure recognizes that there may be situations where not all of the information of AMVP needs to be explicitly signaled. Instead, there may be situations where some motion information may be inherited, as in merge mode, but other motion information may be explicitly signaled, as in AMVP. This disclosure refers to a “hybrid mode” for coding motion information as a mode in which at least some motion information is signaled in a manner substantially similar to merge mode, some motion information is signaled in a manner substantially similar to AMVP, and unsignaled motion information is inferred as in merge mode. Two explicit examples, referred to as partial merge mode and partial AMVP mode, are described below, with respect to Table 2:

TABLE 2

| | | | Reference | | |
|---|---|---|---|---|---|
| Mode | InterDir | Merge Index | Index | AMVP Index | MVD |
| Merge | | x | | | |
| Partial Merge | | x | x | | |
| Partial AMVP | | x | | | x |
| AMVP | x | | x | x | x |

As shown in Table 2, this disclosure describes two examples of hybrid modes: partial merge mode and partial AMVP mode. In partial merge mode, a reference index is explicitly signaled, and other information (such as a motion vector and inter-prediction direction) may be inherited from a merge candidate indicated by the merge index value that is also explicitly signaled. In particular, the motion vector may be scaled when using partial merge mode, as explained in greater detail below. In this manner, an actual motion vector used to code a current block may refer to a reference picture indicated by the explicitly signaled reference index. In partial AMVP mode, a motion vector difference value is explicitly signaled, and other information (such as an inter-prediction direction and a reference index) may be inherited from a merge candidate indicated by the merge index value that is also explicitly signaled. Although the examples of partial merge and partial AMVP modes are described in this disclosure, it should be understood that other hybrid modes may also be used in accordance with the techniques of this disclosure.

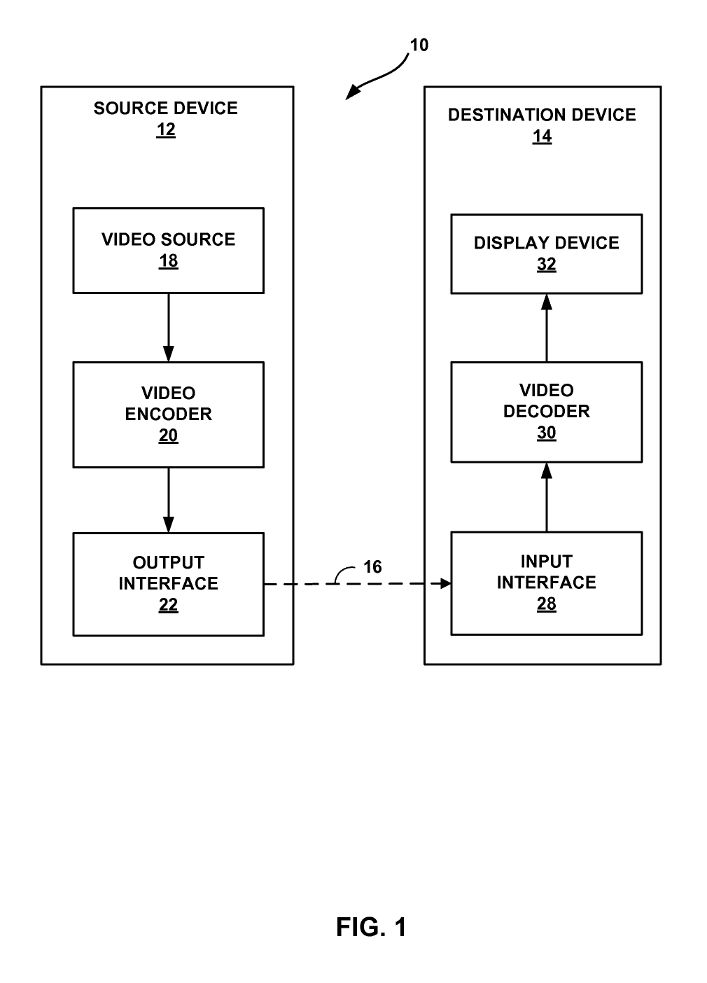

FIG. 1 is a block diagram illustrating an example video encoding and decoding system 10 that may utilize techniques for coding motion information using a hybrid mode. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for coding motion information using a hybrid mode. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for coding motion information using a hybrid mode may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In accordance with the techniques of this disclosure, video encoder 20 and video decoder 30 may be configured to code motion information for a PU using a hybrid mode. That is, video encoder 20 and video decoder 30 may be configured to code motion information for an inter-prediction coded PU using a hybrid motion information coding mode. The hybrid motion information coding mode (also referred to herein as a “hybrid mode”) may include coding a merge index syntax element of the motion information in a manner substantially conforming to merge mode (e.g., merge mode of HEVC) and coding a different syntax element of the motion information in a manner substantially conforming to advanced motion vector prediction (AMVP) mode (e.g., AMVP mode of HEVC).

In general, in merge mode, a video coder (such as video encoder 20 and video decoder 30) determines a spatially or temporally neighboring block that is inter-prediction coded to a current inter-prediction coded block, and uses motion information of the neighboring block to code the current block. Thus, the current block may be said to inherit or incorporate the motion information of the neighboring block. In this manner, only a merge index (which indicates a location of a candidate inside the merge candidate list that is formed from motion information of neighboring blocks) need be coded. Because all other motion information is inherited from the neighboring block, no other motion information need be coded for a PU having motion information coded using merge mode.

By contrast, for AMVP mode, nearly all motion information is explicitly coded. That is, a video coder codes inter-prediction direction information, which indicates whether a motion vector for the current PU refers to a reference picture having an earlier presentation time or a later presentation time than the presentation time of the current frame including the current PU. This provides an indication of whether the reference picture is included in a list of pictures having earlier presentation times than the current picture (e.g., RefPicList0) or a list of pictures having later presentation times than the current picture (e.g., RefPicList1).

The video coder also codes a reference index, which is an index into the list corresponding to the inter-prediction direction. The video coder further codes an AMVP index, which indicates a neighboring block whose motion vector will act as a motion vector predictor for the current PU. Moreover, the video coder codes a motion vector difference value, which represents a difference between the motion vector predictor and the actual motion vector used to code the current PU. For example, video encoder 20 may perform a motion search to determine a motion vector for a current PU, then calculate the difference between the motion vector and a motion vector predictor. Video decoder 30, on the other hand, may receive the motion vector difference value and the AMVP index, use the AMVP index to determine a motion vector predictor, then add the motion vector difference value to the motion vector predictor to reproduce the original motion vector for the current PU.

Table 2, described above, illustrates two examples of hybrid modes (that is, hybrid motion information coding modes). In particular, Table 2 summarizes a partial merge mode and a partial AMVP mode. These modes are described in greater detail below.

In partial merge mode, video encoder 20 and video decoder 30 may be configured to code both a merge index and a reference index. In this manner, a merge index and a reference index may be transmitted or otherwise sent from source device 12 to destination device 14 for the same PU. Video encoder 20 may determine the reference index by calculating a rate-distortion cost. Video encoder 20 and video decoder 30 may scale a motion vector predictor from a neighboring block (that is, a neighboring merge candidate) based on differences between a picture order count (POC) value of a reference picture pointed to by the motion vector predictor and a POC value of the current picture, and between a POC value of a reference picture pointed to by the motion vector for the merge candidate and the POC value of the current picture.

In partial AMVP mode, video encoder 20 and video decoder 30 may be configured to code both a merge index and MVD information. Thus, merge index data and MVD information may be transmitted or otherwise sent from source device 12 to destination device 14. In this example, the inter-prediction direction and reference index are inherited from a candidate in the merge candidate list formed from motion information of neighboring (e.g., spatially or temporally neighboring) block to a current PU (e.g., as indicated by the merge index), while the merge index and MVD are explicitly coded. In this manner, the MVD may be calculated relative to a motion vector of the merge index, and the inter-prediction direction and reference index may be inherited from the candidate indicated by the merge index.

Accordingly, video encoder 20 may perform a motion search when inter-prediction coding a block of video data to produce a motion vector for the block. Video encoder 20 may then determine an appropriate motion information coding mode for coding the motion vector. For example, video encoder 20 may determine whether merge mode, partial merge mode, partial AMVP mode, AMVP mode, or another motion information coding mode (e.g., another hybrid mode) is appropriate, e.g., based on rate-distortion performance of the various motion information coding modes. Video encoder 20 may then encode the motion information for the current block using the determined motion information coding mode, and code the current block using the motion information using an inter-prediction mode. Video encoder 20 may further code information indicative of which of the motion information coding modes was used. In some cases, the indication of which motion information coding mode was used may be included in the motion information itself, such that the mode can be determined implicitly.

Video decoder 30, in turn, may receive a coded block of video data, as well as coded motion information for the coded block. Video decoder 30 may determine which of the motion information coding modes to use to decode the coded motion information, e.g., using the coded motion information itself or based on other signaling information associated with the block. Video decoder 30 may then decode the coded motion information using the motion information coding mode. This decoding process may yield a merge index (for merge mode, partial merge mode, or partial AMVP mode) or an AMVP merge index (for AMVP mode), an inter-prediction direction (explicitly signaled or implicitly determined), a reference index (explicitly signaled or implicitly determined), and, for partial AMVP mode and AMVP mode, a motion vector difference (MVD) value. Video decoder 30 may determine a motion vector for the current block using the decoded motion information, and decode the current block using the motion vector.

For example, in merge mode and partial merge mode, video decoder 30 may determine that the motion vector of the block indicated by the merge index is to be used as the motion vector for the current block (or a scaled version of the motion vector, in the case of partial merge mode). As another example, for AMVP mode and partial AMVP mode, video decoder 30 may determine a motion vector predictor and add the motion vector difference value to the motion vector predictor. In AMVP mode, video decoder 30 may determine the motion vector predictor as the motion vector corresponding to the AMVP index. In partial AMVP mode, video decoder 30 may determine the motion vector predictor as the motion vector corresponding to the merge index.

In any case, video decoder 30 may then use the determined motion vector to decode the current block. That is, video decoder 30 may retrieve a reference block using the motion vector from the picture corresponding to the reference index in a list of pictures corresponding to the inter-prediction direction (e.g., RefPicList0 or RefPicList1). Video decoder 30 may further decode residual data for the current block, representing a difference between the reference block and the original block, and add the residual block to the reference block to reproduce the original block.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

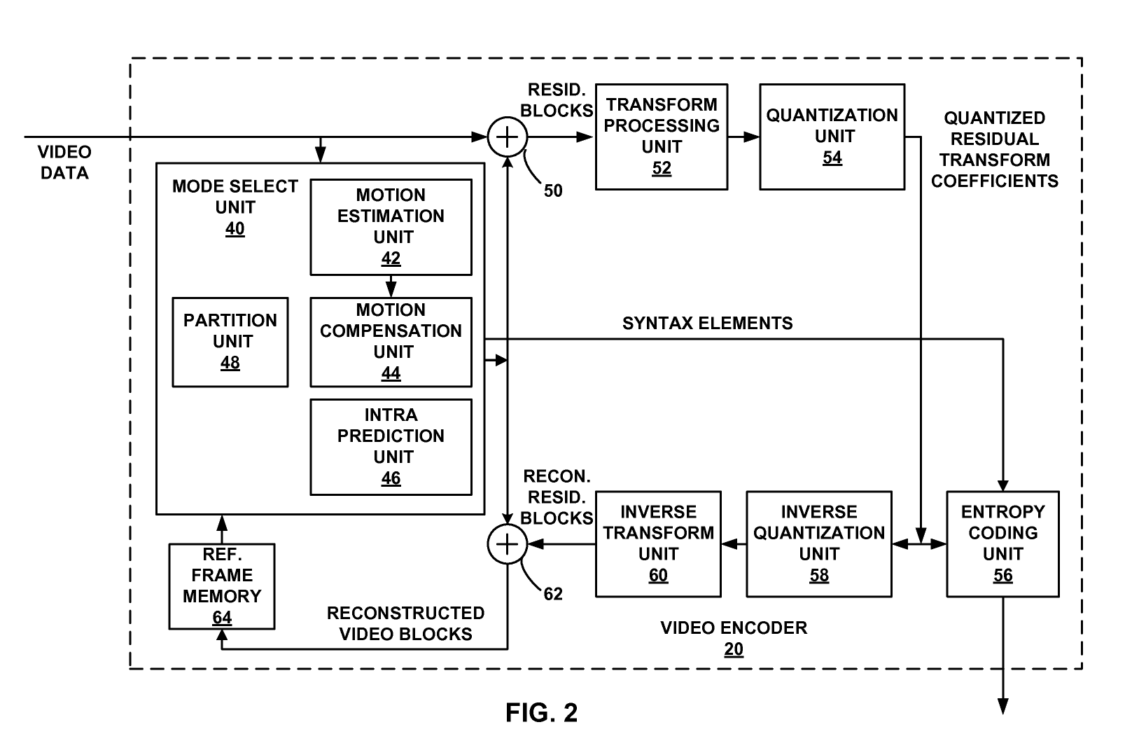

FIG. 2 is a block diagram illustrating an example of video encoder 20 that may implement techniques for coding motion information using a hybrid mode. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference pictures to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference picture. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

In accordance with the techniques of this disclosure, mode select unit 40, or another unit of video encoder 20 (e.g., motion compensation unit 44), may determine syntax elements for motion information related to the motion vector determined by motion estimation unit 42. In particular, mode select unit 40 may select a motion information coding mode to use to code motion information of a current block of video data. The selected motion information coding mode may comprise merge mode, AMVP mode, or a hybrid mode, such as partial merge mode or partial AMVP mode. As shown in Table 2, in merge mode, the syntax elements of motion information may include a merge index, whereas in AMVP mode, the syntax elements may include an inter-prediction direction, a reference index, an AMVP index, and an MVD.

In a hybrid mode, the syntax elements may include a combination of syntax elements of merge mode and AMVP mode. For example, in partial merge mode, the syntax elements may include a merge index and a reference index. In partial AMVP mode, as another example, the syntax elements may include a merge index and an MVD value. When syntax elements are not coded for a particular element of the motion information, a value for the element may be inferred or inherited from a candidate formed from motion information of neighboring blocks, e.g., as indicated by the merge index. That is, mode select unit 40 may determine an appropriate candidate from which to infer the value for the element. In general, all inferred values will be inferred from the same candidate, that is, the candidate corresponding to the merge index. Mode select unit may provide values for other syntax elements that are to be explicitly coded to entropy coding unit 56, which may entropy code the syntax elements, e.g., using context adaptive binary arithmetic coding (CABAC).

The examples described above have been described with respect to coding motion information including one motion vector for a block. However, it should also be understood that motion information may include two motion vectors for the block. For example, in bi-prediction modes (B-modes), video encoder 20 may determine two motion vectors for a block. The techniques of this disclosure may also be applied when coding two motion vectors for a block.

In some examples, the motion information for a block itself may indicate a motion information coding mode used to code the motion information for the block. For example, if only partial merge mode is available, in addition to merge mode and AMVP mode, video encoder 20 may add a partial merge mode flag, which is signaled only when a merge flag indicates that merge mode is not used. In this manner, if merge mode is not used, the partial merge flag may indicate whether partial merge mode or AMVP mode is used. Similarly, if only partial AMVP mode is available, in addition to merge mode and AMVP mode, a partial AMVP flag may be used with similar semantics to the partial merge flag described above. Thus, more generally, a partial mode flag may be introduced to indicate whether a single partial mode (also referred to as a hybrid mode) is used. As an alternative to the example above, the partial mode flag may be coded when the merge flag indicates that merge mode is used, and when the merge flag indicates that merge mode is not used, AMVP mode may be inferred.

If two hybrid modes are available, e.g., partial merge and partial AMVP modes, in addition to merge mode and AMVP mode, two additional flags may be signaled. A merge flag may initially indicate whether merge mode is used. If the merge flag indicates that merge mode is not used, a partial mode flag may be signaled to indicate whether a partial mode (that is, a hybrid mode) is used. If the partial mode flag indicates that a partial mode is not used, AMVP mode may be inferred. Alternatively, if the partial mode flag indicates that a partial mode is used, a partial merge flag may be signaled to indicate whether partial merge mode is used or partial AMVP mode flag is used. These techniques may be extended to signal which mode is used when more than two hybrid modes are available. For example, additional binary flags may be added, or, alternatively, an index corresponding to the selected partial mode (that is, hybrid mode) may be signaled.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

In this manner, video encoder 20 of FIG. 2 represents an example of a video encoder configured to encode motion information for a current block of video data using a hybrid motion information coding mode, wherein to encode the motion information, the video encoder is configured to encode a merge index syntax element of the motion information in a manner substantially conforming to a merge mode, and encode at least one additional syntax element of the motion information in a manner substantially conforming to an advanced motion vector prediction (AMVP) mode, and wherein the video encoder is configured to encode the current block using the motion information.

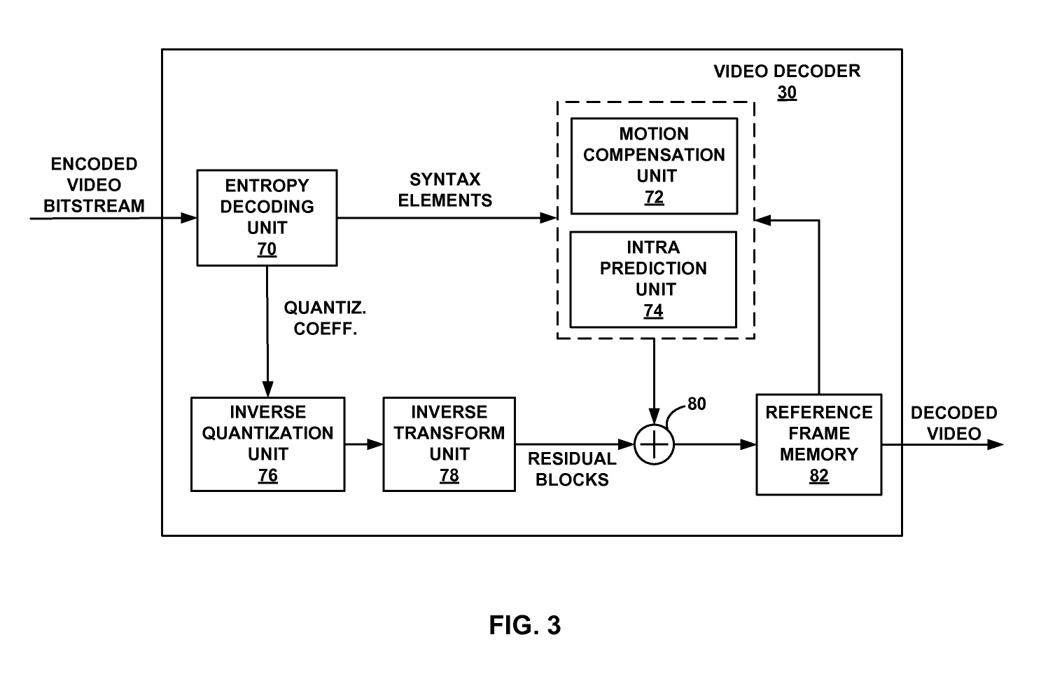

FIG. 3 is a block diagram illustrating an example of video decoder 30 that may implement techniques for coding motion information using a hybrid mode. In the example of FIG. 3, video decoder 30 includes an entropy decoding unit 70, motion compensation unit 72, intra prediction unit 74, inverse quantization unit 76, inverse transformation unit 78, reference picture memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

In accordance with the techniques of this disclosure, entropy decoding unit 70 may decode syntax elements related to motion information for a current block of video data. The syntax elements may include data indicating a motion information coding mode used to code motion information for the current block of video data, as well as motion information for the current block coded according to the indicated motion information coding mode. As explained above, the syntax elements may include one or more flags indicating which motion information coding mode is used, e.g., one of merge mode, partial merge mode, partial AMVP mode, AMVP mode, or another motion information coding mode (e.g., another hybrid mode).

Based on the determined motion information coding mode, motion compensation unit 72 may determine which motion information syntax elements to expect, to correctly parse the syntax elements. For example, when the motion information coding mode is partial merge mode, motion compensation unit 72 may be configured to receive a merge index and a reference index. As another example, when the information coding mode is partial AMVP mode, motion compensation unit 72 may be configured to receive a merge index and a motion vector difference value.

When the indicated motion information coding mode is partial merge mode, motion compensation unit 72 may determine a candidate, corresponding to a value for the received merge index, in a merge candidate list that is formed from motion information of neighboring blocks. The neighboring blocks may comprise spatial neighbors or a temporal neighbor. Motion compensation unit 72 may infer a value for the inter-prediction direction, to determine a list of reference pictures in which a reference picture for the current block is included.

In the example of partial merge mode, motion compensation unit 72 receives a syntax element representative of a reference index, that is, an index into the list of reference pictures that identifies the reference picture to be used to code the current block. However, a scaled version of the motion vector of the neighboring block may be used to identify a reference block in the reference picture relative to the location of the current block. Thus, a motion vector difference value need not be coded for partial merge mode, but instead, the motion vector can be inferred from the candidate corresponding to the merge index, then scaled for the current block, based on differences in POC values between reference pictures for the current block and for the candidate relative to the POC value of the current picture.

When the indicated motion information coding mode is partial AMVP merge mode, motion compensation unit 72 may determine a merge candidate corresponding to a value for the received merge index. The merge candidate is formed from motion information of neighboring blocks which may comprise spatial neighbors or a temporal neighbor. Motion compensation unit 72 may infer a value for the inter-prediction direction, to determine a list of reference pictures in which a reference picture for the current block is included. In the example of partial AMVP mode, motion compensation unit 72 may also infer a value for a reference index into the list of reference pictures. However, motion compensation unit 72 may decode a motion vector difference value. Motion compensation unit 72 may treat the motion vector of the candidate as a motion vector predictor, and then reproduce the motion vector for the current block by adding the motion vector difference value to the motion vector predictor.

In either case, motion compensation unit 72 may use the motion vector determined according to the motion information coding mode to decode the current block. That is, motion compensation unit 72 may retrieve the reference block from the reference picture corresponding to the reference index in the list of reference pictures corresponding to the inter-prediction direction. Motion compensation unit 72 may provide this reference block to summer 80 to be combined with reproduced residual data for the current block, as explained in greater detail below.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In this manner, video decoder 30 of FIG. 3 represents an example of a video decoder configured to decode motion information for a current block of video data using a hybrid motion information coding mode, wherein to decode the motion information, the video decoder is configured to decode a merge index syntax element of the motion information in a manner substantially conforming to a merge mode, and decode at least one additional syntax element of the motion information in a manner substantially conforming to an advanced motion vector prediction (AMVP) mode, and wherein the video decoder is configured to decode the current block using the motion information.

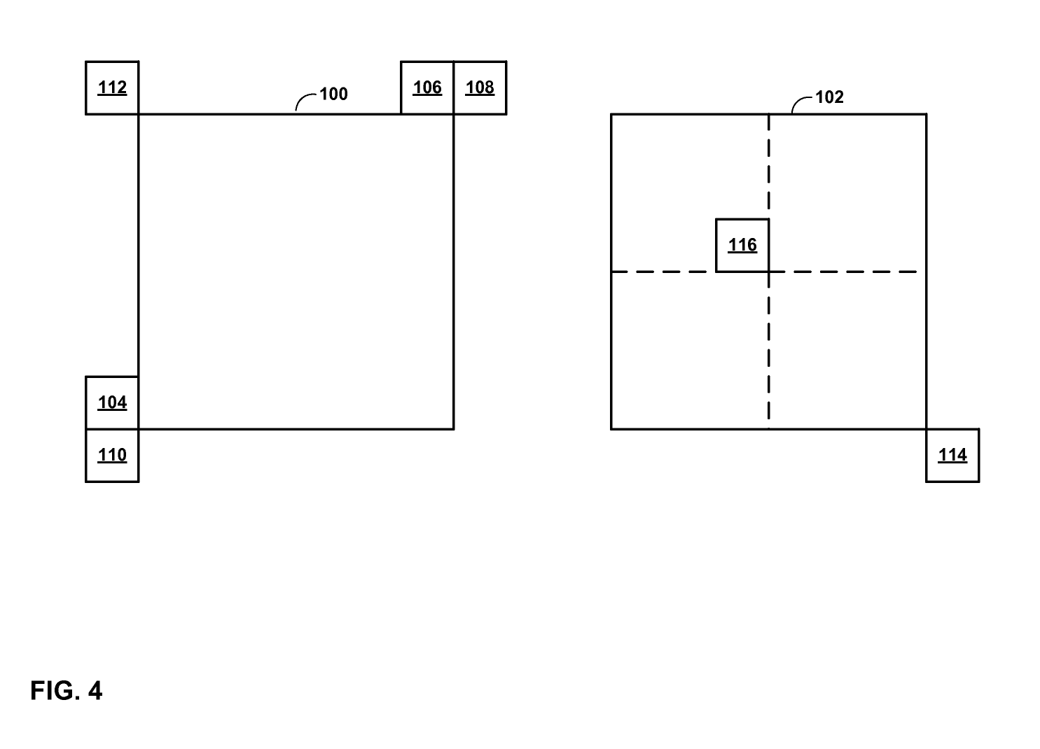

FIG. 4 is a conceptual diagram illustrating example merge candidates for a current block 100. Merge candidates for current block 100 include spatial neighbor blocks 104, 106, 108, 110, and 112, and temporal neighbor blocks 114, 116. In particular, block 102 is co-located with block 100 in a different, previously coded picture. That is, the upper-left corner of block 100 has the same (x, y) coordinate as the upper-left corner of block 102, but a picture order count (POC) value for a picture including block 100 is different from the POC value for a picture including block 102.

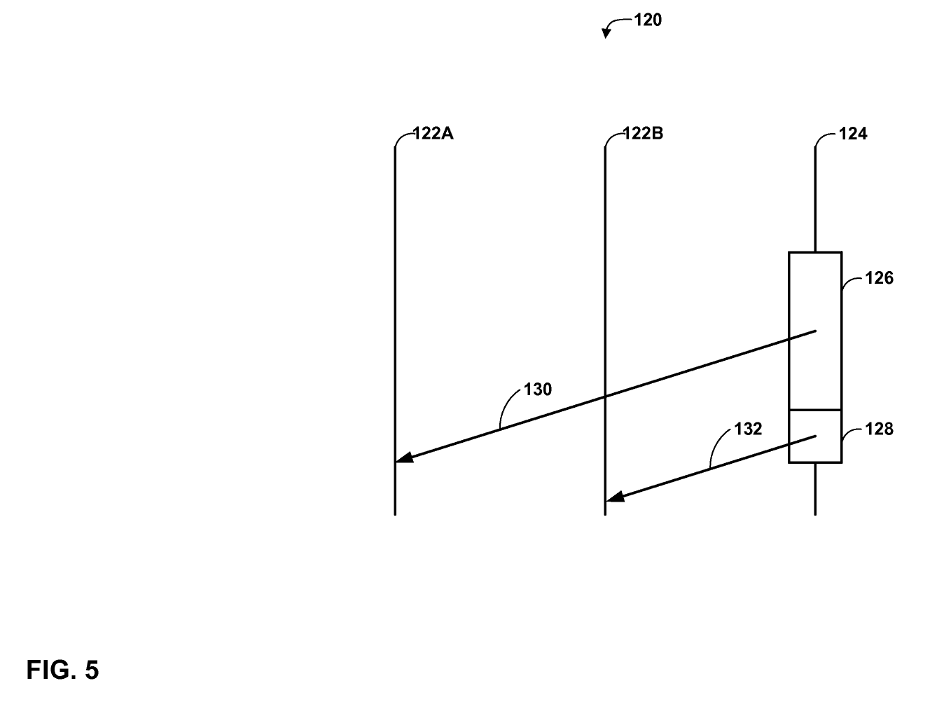

FIG. 5 is a conceptual diagram illustrating an example current block 126 including a motion vector 130 that is coded using a partial merge mode. FIG. 5 illustrates a set of pictures 120, including reference pictures 122A, 122B, and current picture 124. Current picture 124 includes current block 126 and neighboring block 128. For purposes of example, suppose that block 126 of FIG. 5 corresponds to block 100 of FIG. 4. Suppose further that neighboring block 128 of FIG. 5 corresponds to neighboring block 104 of FIG. 4. Reference pictures 122A and 122B have different POC values from each other, as well as from current picture 124.

In this example, motion information of current block 126 is coded using partial merge mode with respect to neighboring block 128. Accordingly, a video coder, such as video encoder 20 or video decoder 30, will code a merge index value corresponding to neighboring block 128. Neighboring block 128 will include motion information representing an inter-prediction direction, and current block 126 will inherit the same inter-prediction direction as neighboring block 128. Therefore, if the POC value of reference picture 122B is less than the POC value of current picture 124, the POC value of reference picture 122A will also be less than the POC value of current picture 124. On the other hand, if the POC value of reference picture 122B is greater than the POC value of current picture 124, the POC value of reference picture 122A will also be greater than the POC value of current picture 124.

Whether the POC value of reference pictures 122A, 122B is less than or greater than the POC value of current picture 124 is indicative of a reference picture list from which an indication of the reference picture will be identified. In general, RefPicList0 (also referred to simply as “List 0”) includes reference pictures having POC values less than the POC value of current picture 124, while RefPicList1 (also referred to as “List 1”) includes reference pictures having POC values greater than the POC value of current picture 124.

Because motion information for current block 126 is coded using partial merge mode, a reference index is coded for current block 126, where the reference index corresponds to reference picture 122A in the corresponding list, e.g., List 0 or List 1. Motion vector 132 for neighboring block 128 serves as the basis for determining motion vector 130 of current block 126. However, because the POC values for reference picture 122A and reference picture 122B are different, motion vector 132 may be scaled in order to form motion vector 130. That is, video encoder 20 and video decoder 30 may code current block 126 using motion vector 130, which may comprise a scaled version of motion vector 132.

In some case, the scaling operation is relatively costly for hardware implementations. Accordingly, in some examples, video coders, such as video encoder 20 and video decoder 30, may replace the conventional scaling operations with multiplication or shift operations. Video coders may be configured to check and signal whether reference pictures satisfy one of the following conditions:

Distance(currPOC,candRefPOC)=2ⁿ,where n is an integer (1)

or

Distance(currPOC,currRefPOC)=m*Distance(currPOC,candRefPOC),where m is an integer (2)

In the conditions above, distance(A,B) may be used to calculate the distance between picture A and B in display order. If condition (1) is satisfied, motion vector 130 may be set equal to distance(currPOC, currRefPOC)*(motion vector 132)>>n, where “>>” is right shift operation. If condition (2) is satisfied, motion vector 130 may be set equal to m*(motion vector 132). Since not all of the reference frames in the reference list satisfy at least one of the conditions, the refIdx bits can be saved to signal a smaller set of reference pictures.

In other words, to scale a motion vector according to condition (1), a video coder may be configured to determine whether a difference between a POC value of a current picture including the current block and the POC value of the reference picture of the candidate corresponding to the merge index can be expressed as a value 2ⁿ, wherein n is an integer, and when the difference can be expressed as the value 2ⁿ, the video coder may calculate the scaled motion vector (that is, motion vector 130) as being equal to distance(currPOC, currRefPOC) times motion vector 132, corresponding to the merge index syntax element, and bitwise right-shifted by n. Here distance(currPOC, currRefPOC) represents a difference between a POC value of the current picture including the current block and the POC value of the reference picture of the current block.

Likewise, to scale a motion vector according to condition (2), a video coder may be configured to determine whether a difference between a POC value of a current picture including a current block and the POC value of the reference picture of the current block can be expressed as a value equal to m times a difference between the POC value of the current picture and a POC value of a reference picture of the candidate corresponding to the merge index, wherein m is an integer, and when the difference can be expressed as the value m times the difference, the video coder may calculate the scaled motion vector as being equal to m times the motion vector corresponding to the merge index.

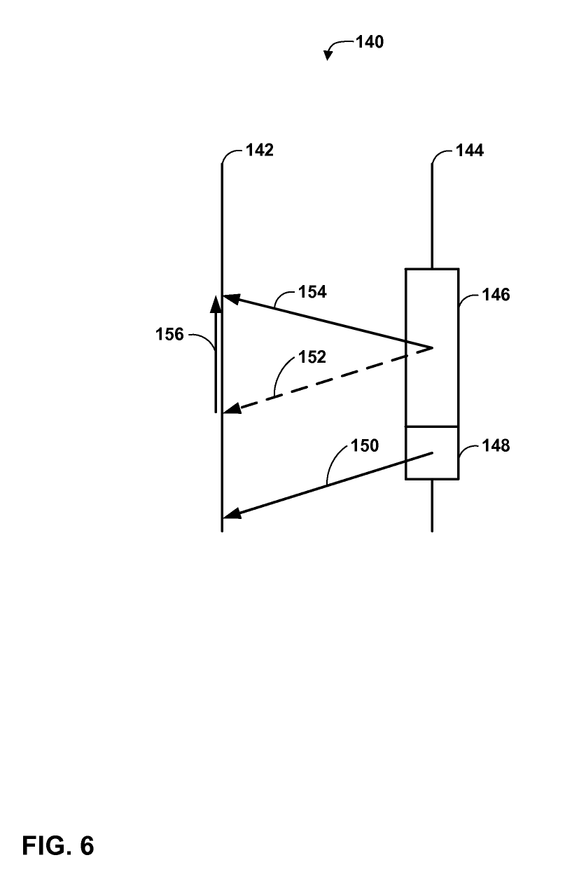

FIG. 6 is a conceptual diagram illustrating an example current block 146 including motion information that is coded using a partial AMVP mode. Pictures 140 include current picture 144 and reference picture 142. Current picture 144 includes current block 146 and neighboring block 148, which are coded relative to reference picture 142, in this example. In this example, current block 146 is coded using motion vector 154. Neighboring block 148 is selected, in this example, as a merge candidate for current block 146. That is, certain motion information is inherited from neighboring block 148 as indicated by the partial AMVP mode, such as an inter-prediction direction and a reference index. Because the inter-prediction direction and reference index are inherited by current block 146 from neighboring block 148, motion vector 150 and motion vector 154 will correspond to the same reference picture, namely, reference picture 142, in the example of FIG. 6.

Because motion information for current block 146 is coded using a partial AMVP mode, motion vector 150 of neighboring block 148 is used to form motion vector predictor 152. The difference between motion vector predictor 152 and motion vector 154 (that is, the motion vector actually used to code current block 146) is represented by motion vector difference 156. In this manner, video coders, such as video encoder 20 and video decoder 30, may code motion vector difference 156 explicitly, as well as a merge index that corresponds to neighboring block 148 relative to current block 146. In this manner, video encoder 20 may calculate motion vector difference 156 as the difference between motion vector 154 and motion vector predictor 152, whereas video decoder 30 may reproduce motion vector 154 by adding motion vector 156 to motion vector predictor 152.

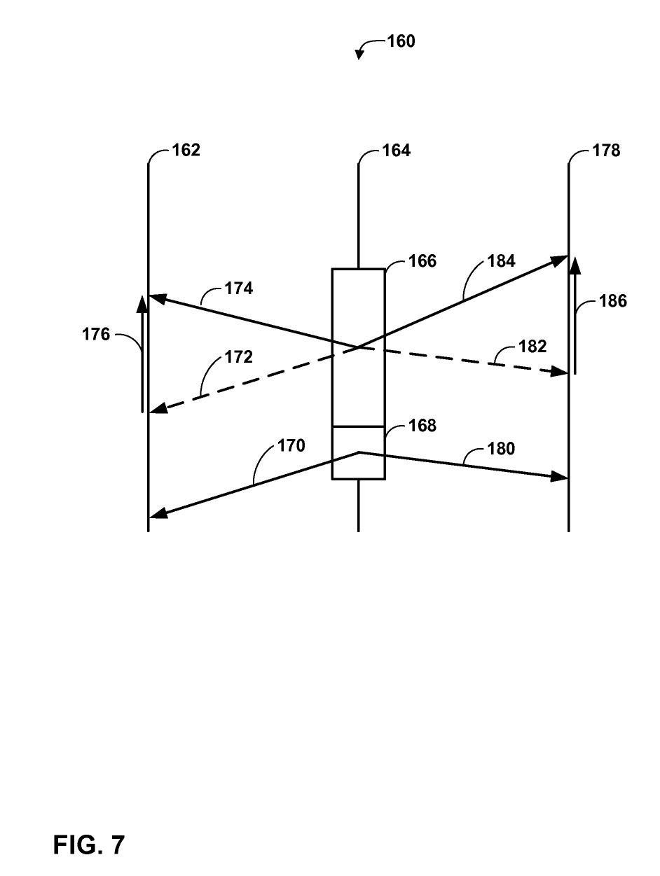

FIG. 7 is a conceptual diagram illustrating another example current block 166 that includes motion information coded using partial AMVP mode. Pictures 160 include current picture 164 and reference pictures 162, 178. Pictures 160 are illustrated in display order, such that reference picture 162 has a POC value that is less than the POC value of current picture 164, whereas reference picture 178 has a POC value that is greater than the POC value of current picture 164.

In this example, current block 166 of current picture 164 is coded in a bi-prediction mode, such that current block 166 includes two motion vectors, namely, motion vectors 174 and 184. In this example, neighboring block 168 is also coded in a bi-prediction mode, such that neighboring block 168 includes motion vectors 170, 180. Motion vector 170 may be used to form motion vector predictor 172, while motion vector 180 may be used to form motion vector predictor 182. Motion vector difference 176 represents the difference between motion vector 174 and motion vector predictor 172, while motion vector difference 186 represents the difference between motion vector 184 and motion vector predictor 182.

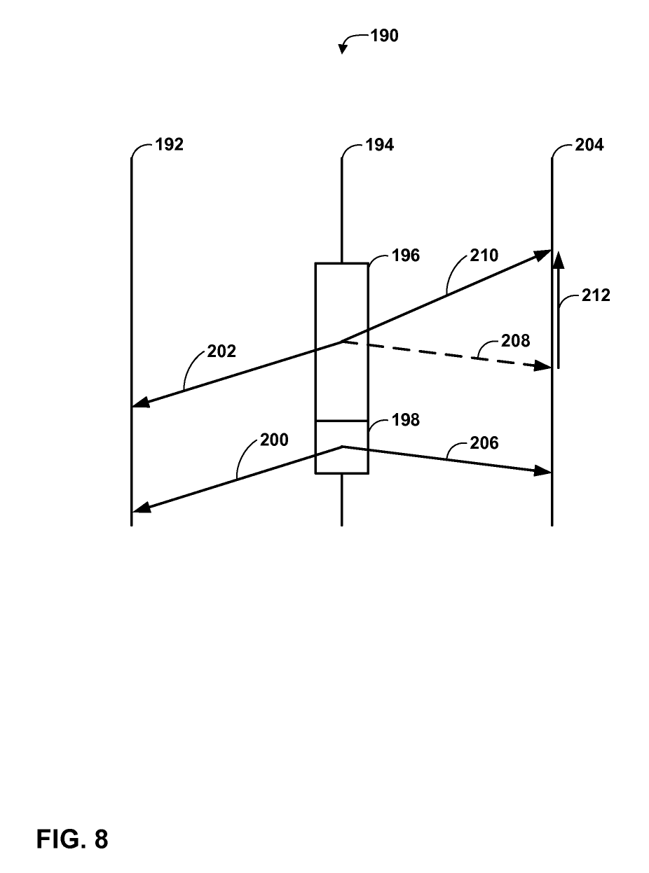

FIG. 8 is a conceptual diagram illustrating another example current block 196 that includes motion information coded using partial AMVP mode. Pictures 190 include current picture 194 and reference pictures 192, 204. Pictures 190 are illustrated in display order, such that reference picture 192 has a POC value that is less than the POC value of current picture 194, whereas reference picture 204 has a POC value that is greater than the POC value of current picture 194.

In this example, current block 196 of current picture 194 is coded in a bi-prediction mode, such that current block 166 includes two motion vectors, namely, motion vectors 202, 210. In this case, motion vector 202 indicates the location of a reference block in reference picture 192, while motion vector 210 indicates the location of a reference block in reference picture 204. Neighboring block 198 is selected as a merge candidate in the example of FIG. 8, such that certain motion information is inherited from neighboring block 198, which includes motion vectors 200 and 206.

Unlike the example of FIG. 7, in the example of FIG. 8, motion vector 202 of current block 196 is forced to be equal to motion vector 200 of neighboring block 198. However, motion vector 206 of neighboring block 198 is used to form motion vector predictor 208, and motion vector difference 212 represents the difference between motion vector 210 and motion vector predictor 208.

Thus, FIG. 8 illustrates an example in which, when motion information for a bi-predicted block is coded using partial AMVP mode, only one direction of prediction includes a motion vector difference value, whereas the other direction is coded in a manner substantially similar to merge mode. Video coders may be configured to code data indicating which direction of prediction includes the motion vector difference value. Alternatively, the direction including the motion vector difference value may be inferred based on prediction modes of neighboring blocks, motion information (e.g., reference index, inter-prediction direction, motion vector difference, motion vector, reference picture quality, or POC distance), and/or block shape and size (e.g., CU, PU, and/or TU shape and size), or any combination thereof.

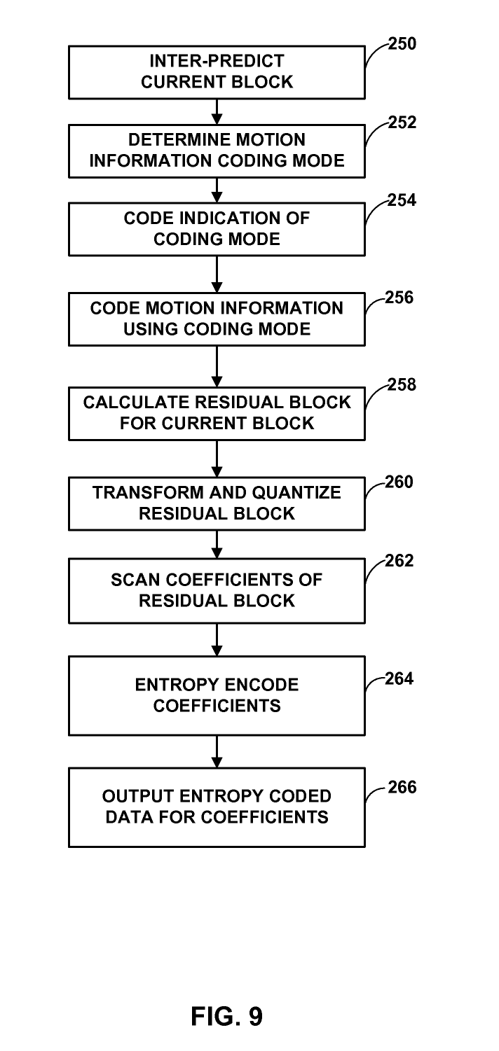

FIG. 9 is a flowchart illustrating an example method for encoding a current block and encoding motion information for the current block. The current block may comprise a current CU or a portion of the current CU, e.g., a PU. Although described with respect to video encoder 20 (FIGS. 1 and 2), it should be understood that other devices may be configured to perform a method similar to that of FIG. 9.

In this example, video encoder 20 initially inter-predicts the current block (250). In this example, video encoder 20 determines motion information, including at least one motion vector, for the current block, e.g., using motion estimation unit 42. The motion information indicates the location of a reference block in a reference picture. The motion information also includes a reference picture index into a reference picture list (e.g., List 0 or List 1) that identifies the reference picture. Video encoder 20 further determines a motion information coding mode (252) to be used to code the motion information.

Video encoder 20 may select merge mode if a neighboring block (e.g., a spatial or temporal neighboring block) includes a motion vector that is substantially similar to, or identical to, a motion vector calculated by motion estimation unit 42 for the current block. On the other hand, video encoder 20 may select AMVP mode if there is not a more suitable mode and several syntax elements need to be explicitly coded. However, in accordance with the techniques of this disclosure, video encoder 20 may select a hybrid motion vector coding mode for coding the motion information of the current block. For example, video encoder 20 may select partial merge mode or partial AMVP mode, if certain syntax can be inherited from a neighboring block without excess bits being needed for explicitly signaling other syntax elements.

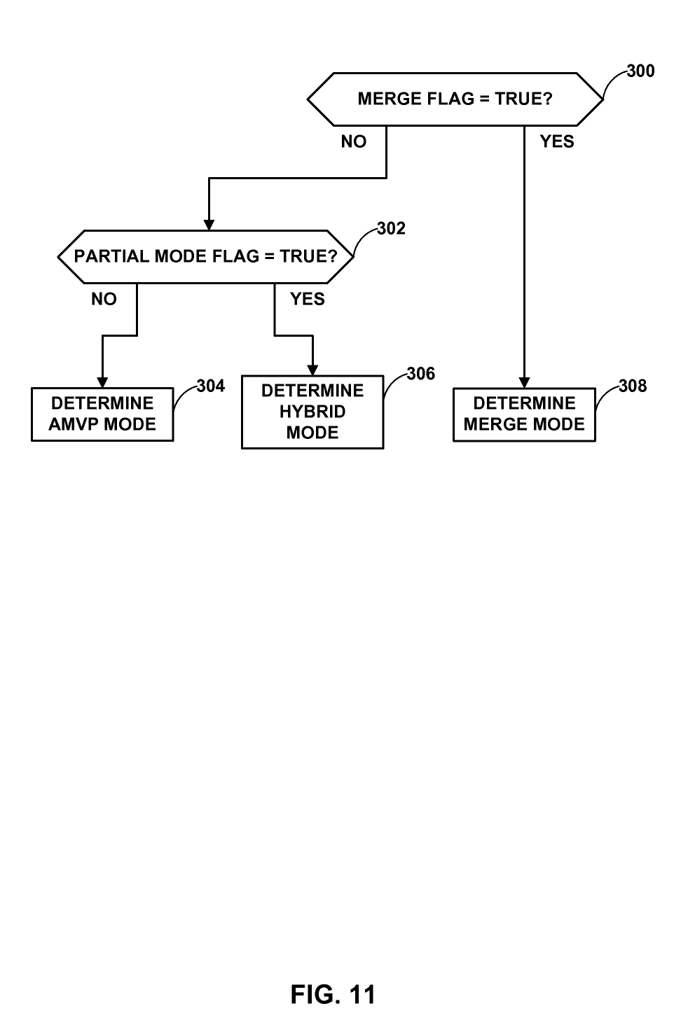

Video encoder 20 may then encode an indication of the determined motion information coding mode (254). Detailed examples of encoding an indication of a determined motion information coding mode are explained in greater detail with respect to FIGS. 11-13 below. Video encoder 20 may further code the motion information using the determined motion information coding mode (256). Assuming that a hybrid mode is selected, video encoder 20 may code a merge index in a manner substantially conforming to merge mode, and at least one other syntax element of motion information in a manner substantially conforming to AMVP mode.

Video encoder 20 may also calculate a residual block for the current block, e.g., to produce a transform unit (TU) (258). To calculate the residual block, video encoder 20 may calculate pixel-by-pixel differences between the original, uncoded block and the reference block for the current block. Video encoder 20 may then transform and quantize coefficients of the residual block (154). Next, video encoder 20 may scan the quantized transform coefficients of the residual block (156). During the scan, or following the scan, video encoder 20 may entropy encode the coefficients (158). For example, video encoder 20 may encode the coefficients using CAVLC or CABAC. Video encoder 20 may then output the entropy coded data of the block (160).

In this manner, FIG. 9 represents an example of a method including coding motion information for a current block of video data using a hybrid motion information coding mode, wherein coding the motion information comprises coding a merge index syntax element of the motion information in a manner substantially conforming to a merge mode, and coding at least one additional syntax element of the motion information in a manner substantially conforming to an advanced motion vector prediction (AMVP) mode, and coding the current block using the motion information.

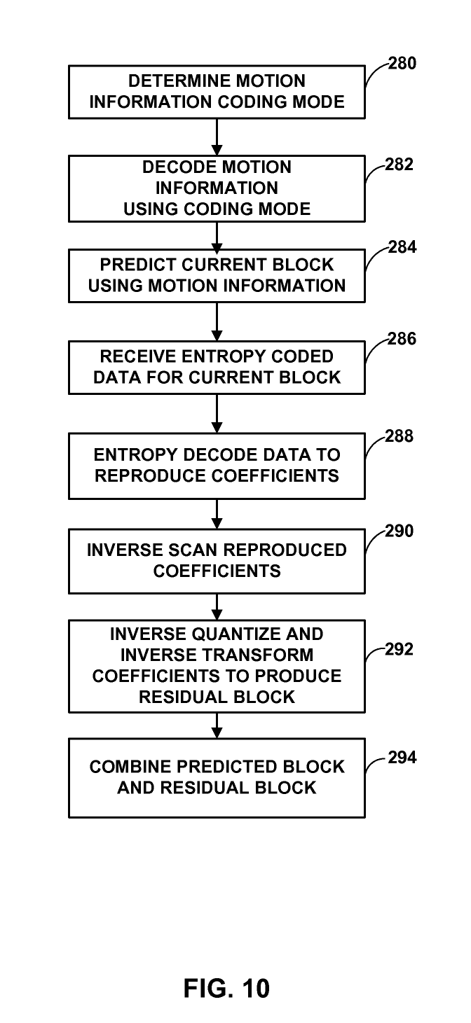

FIG. 10 is a flowchart illustrating an example method for decoding motion information for a current block of video data, and for decoding the current block using the motion information. The current block may comprise a current CU or a portion of the current CU (e.g., a PU). Although described with respect to video decoder 30 (FIGS. 1 and 3), it should be understood that other devices may be configured to perform a method similar to that of FIG. 10.

Video decoder 30 may initially determine a motion information coding mode for a current block (280). For example, video decoder 30 may use processes similar to those of FIGS. 11-13 to determine the motion information coding mode, as discussed in greater detail below. Video decoder 30 may further decode the motion information for the current block using the determined motion information coding mode (282).

For example, if the motion information coding mode is partial merge mode, video decoder 30 may determine a candidate using a merge index, infer an inter-prediction direction based on the candidate, determine a reference picture from a reference list corresponding to the inter-prediction direction using a reference index, and scale a motion vector of the candidate to produce a motion vector for the current block.

As another example, if the motion information coding mode is partial AMVP mode, video decoder 30 may determine a candidate using a merge index, infer an inter-prediction direction based on the candidate, determine a reference picture from a reference list corresponding to the inter-prediction direction using a reference index inferred from the candidate, determine a motion vector predictor based on a motion vector of the candidate, and reproduce a motion vector for the current block by adding a decoded motion vector difference value to the motion vector predictor.

Video decoder 30 may further predict the current block using the decoded motion information (284), retrieving a reference block. Video decoder 30 may also receive entropy coded data for the current block, such as entropy coded data for coefficients of a residual block corresponding to the current block (286). Video decoder 30 may entropy decode the entropy coded data to reproduce coefficients of the residual block (288). Video decoder 30 may then inverse scan the reproduced coefficients (290), to create a block of quantized transform coefficients. Video decoder 30 may then inverse quantize and inverse transform the coefficients to produce a residual block (292). Video decoder 30 may ultimately decode the current block by combining the reference block and the residual block (294).

In this manner, FIG. 10 represents an example of a method including decoding motion information for a current block of video data using a hybrid motion information coding mode, wherein decoding the motion information comprises decoding a merge index syntax element of the motion information in a manner substantially conforming to a merge mode, and decoding at least one additional syntax element of the motion information in a manner substantially conforming to an advanced motion vector prediction (AMVP) mode, and decoding the current block using the motion information.

FIG. 11 is a flowchart illustrating an example method for determining a motion information coding mode when one hybrid mode is available in addition to merge mode and AMVP mode. In general, the method of FIG. 11 is described with respect to video decoder 30. Video encoder 20 may perform a similar method to signal which motion information coding mode is used by essentially reversing the steps shown in the method of FIG. 11.

In this example, video decoder 30 may first determine whether a merge flag for a current block of video data is set to a value of true (300). If the merge flag is set to true (“YES” branch of 300), video decoder 30 may determine that the motion information coding mode for the current block of video data is merge mode (308). On the other hand, if the merge flag is set to false (“NO” branch of 300), video decoder 30 may determine whether a value of a partial mode flag for the current block is set to a value of true (302).

If the value of the partial mode flag for the current block is true (“YES” branch of 302), video decoder 30 may determine that an available hybrid mode is used to code the motion information for the current block (306). The available hybrid mode may comprise one of partial merge mode and partial AMVP mode, assuming that only one of partial merge mode and partial AMVP mode is available. On the other hand, if the value of the partial mode flag for the current block is false (“NO” branch of 302), video decoder 30 may determine that the motion information for the current block is coded using AMVP mode (304). In this manner, the method of FIG. 11 may be used to code syntax information representative of a hybrid motion information coding mode for a current block.

If using CABAC entropy coding, video decoder 30 may determine a context for the partial mode flag based on information of neighboring blocks. For example, the context may be based on one or more of a motion vector, a motion vector difference value, a reference index value, a prediction direction, a prediction mode, block shape and size (e.g., CU, PU, and/or TU shape and size), transform type, or the like. In this manner, the method of FIG. 11 may be used to distinguish merge mode, AMVP mode, and a hybrid mode, again assuming that only one hybrid mode is available.

Video encoder 20 may perform a reciprocal method to code an indication of which motion information coding mode is used. If video encoder 20 selects merge mode, video encoder 20 may set the merge flag to true and skip coding of the partial mode flag. If video encoder 20 selects the hybrid mode, video encoder 20 may set the merge mode flag to false and the partial mode flag to true. If video encoder 20 selects AMVP mode, video encoder 20 may set the merge mode flag to false and the partial mode flag to false. This is another example of a method including coding syntax information representative of a hybrid motion information coding mode for a current block.

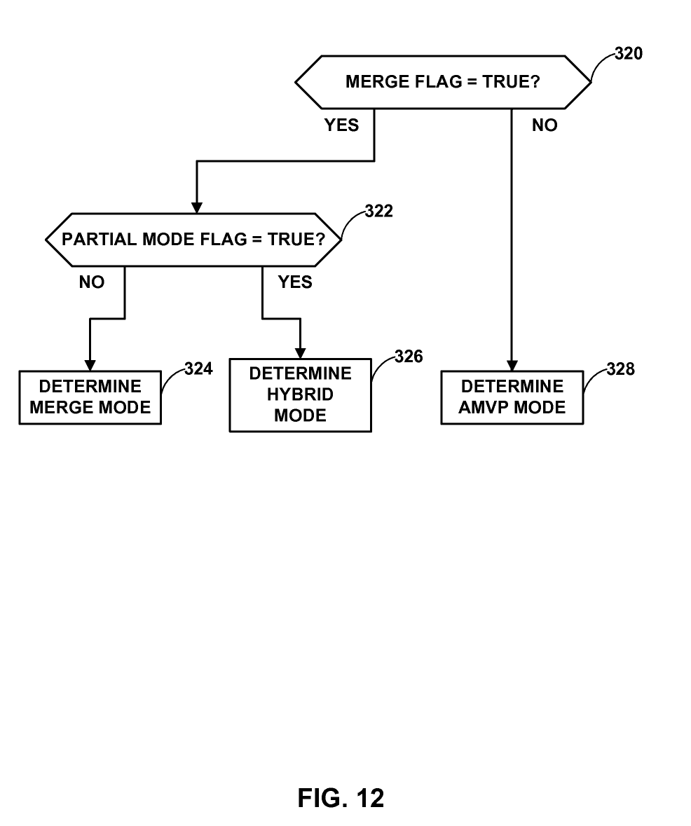

FIG. 12 is a flowchart illustrating another example method for determining a motion information coding mode when one hybrid mode is available in addition to merge mode and AMVP mode. In this example, video decoder 30 may first determine whether a merge flag for a current block of video data is set to a value of true (320). If the merge flag is set to false (“NO” branch of 320), video decoder 30 may determine that the motion information coding mode for the current block of video data is AMVP mode (328). On the other hand, if the merge flag is set to true (“YES” branch of 320), video decoder 30 may determine whether a value of a partial mode flag for the current block is set to a value of true (322).

If the value of the partial mode flag for the current block is true (“YES” branch of 322), video decoder 30 may determine that an available hybrid mode is used to code the motion information for the current block (326). The available hybrid mode may comprise one of partial merge mode and partial AMVP mode, assuming that only one of partial merge mode and partial AMVP mode is available. On the other hand, if the value of the partial mode flag for the current block is false (“NO” branch of 322), video decoder 30 may determine that the motion information for the current block is coded using merge mode (324). Again, video encoder 20 may perform an essentially reciprocal method to encode information indicating which of the motion information coding modes is selected. In this manner, the method of FIG. 12 may be used to code syntax information representative of a hybrid motion information coding mode for a current block.

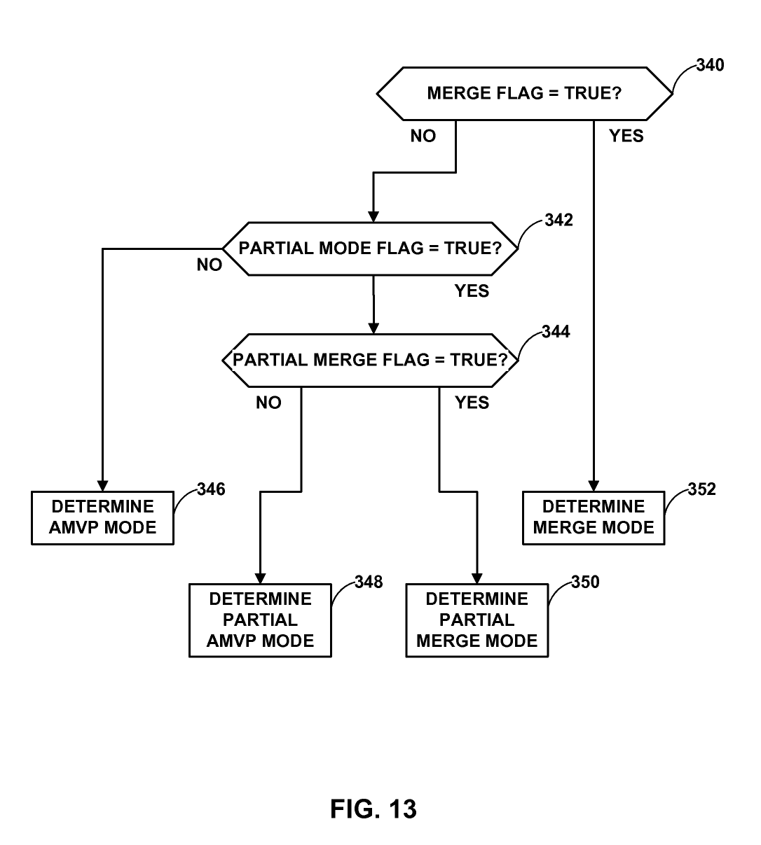

FIG. 13 is a flowchart illustrating an example method for determining a motion information coding mode when two hybrid modes are available in addition to merge mode and AMVP mode. For example, the two hybrid modes may comprise partial merge mode and partial AMVP mode. Again, the method of FIG. 13 is described, for purposes of explanation, with respect to video decoder 30, but a reciprocal method may be performed by video encoder 20 for signaling an indication of a selected motion information coding mode for a current block of video data.

In this example, video decoder 30 determines whether a merge flag for a current block of video data is set to true (340). If the merge flag is set to true (“YES” branch of 340), video decoder 30 may determine that merge mode is used to decode the motion information for the current block of video data (352). On the other hand, if the merge flag is set to false (“NO” branch of 340), video decoder 30 may determine a value of a partial mode flag (342). If the value of the partial mode flag is set to false (“NO” branch of 342), video decoder 30 may determine that AMVP mode is to be used to decode motion information for the current block (346).

If the value of the partial mode flag is set to true (“YES” branch of 342), video decoder 30 may then determine the value of a partial merge flag (344), to determine which hybrid mode is to be used. If the value of the partial merge flag is true (“YES” branch of 344), video decoder 30 may determine that partial merge mode is to be used to decode motion information for the current block (350). However, if the value of the partial merge flag is false (“NO” branch of 344), video decoder 30 may determine that partial AMVP mode is to be used to decode motion information for the current block (348).

As with the examples discussed above, video decoder 30 may decode the values of the merge flag, the partial mode flag, and the partial merge flag using CABAC. When using CABAC to decode the partial mode flag and/or partial merge flag, video decoder 30 may select a context based on one or more of a motion vector, a motion vector difference value, a reference index value, a prediction direction, a prediction mode, block shape and size (e.g., CU, PU, and/or TU shape and size), transform type, or the like. In this manner, the method of FIG. 13 may be used to distinguish between two hybrid modes, as well as merge mode and AMVP mode. That is, the method of FIG. 13 may be used to code syntax information representative of a hybrid motion information coding mode for a current block. Again, video encoder 20 may be configured to perform an essentially reciprocal method to encode an indication of which of the motion information coding modes is used to code motion information for a current block of video data.

The existence of partial mode flag and partial merge flag in the bitstream can be determined by information for previously coded blocks (e.g., motion information, CU/PU/TU shape and size, prediction mode, transform type, and the like). In this case, the encoding complexity and the coding efficiency can be further improved. For example, the neighboring blocks' motion information (prediction direction, reference index, motion vector difference, merge flag, intra/inter mode) can be used to determine whether the partial modes will be available or not for a current block. In certain conditions, one or more of the partial modes may not be available to use for a current block, and no signaling is therefore needed for indicating the corresponding modes that are not available, in that case.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
coding motion information for a current block of video data using a hybrid motion information coding mode, wherein coding the motion information comprises:
coding a merge index syntax element of the motion information in a manner substantially conforming to a merge mode; and
coding at least one additional syntax element of the motion information in a manner substantially conforming to an advanced motion vector prediction (AMVP) mode; and
coding the current block using the motion information.

2. The method of claim 1, wherein the hybrid motion information coding mode comprises a partial merge mode, wherein coding the at least one additional syntax element comprises coding a reference index value that corresponds to an index value for a reference picture, and wherein coding the current block comprises coding the current block relative to a portion of the reference picture.

3. The method of claim 2, further comprising:
determining a motion vector using the merge index syntax element; and
scaling the motion vector based on a picture order count (POC) value of the reference picture,
wherein coding the current block comprises coding the current block using the scaled motion vector.

4. The method of claim 3, wherein scaling comprises:
determining whether a difference between a POC value of a current picture including the current block and the POC value of the reference picture corresponding to the merge index can be expressed as a value 2ⁿ, wherein n is an integer; and
when the difference can be expressed as the value 2ⁿ, calculating the scaled motion vector as being equal to a product of the difference between the POC value of the current picture including the current block and the POC value of the reference picture corresponding to the merge index and the motion vector, wherein the product is bitwise right-shifted by n.

5. The method of claim 3, wherein scaling comprises:
determining whether a difference between a POC value of a current picture including the current block and the POC value of the reference picture can be expressed as a value equal to m times a difference between the POC value of the current picture and a POC value of a reference picture corresponding to the merge index, wherein m is an integer; and
when the difference can be expressed as the value m times the difference, calculating the scaled motion vector as being equal to m times the motion vector corresponding to the merge index.

6. The method of claim 1, wherein the hybrid motion information coding mode comprises a partial AMVP mode, and wherein coding the at least one additional syntax element comprises coding a motion vector difference value.

7. The method of claim 6, further comprising determining a motion vector using the merge index syntax element, wherein coding the current block comprises coding the current block using the motion vector.

8. The method of claim 6, wherein coding the current block comprises encoding the current block, and wherein coding the motion vector difference value comprises calculating the motion vector difference value based on a difference between a motion vector predictor determined according to the partial AMVP mode and a motion vector used to encode the current block.

9. The method of claim 6, wherein coding the current block comprises decoding the current block, and wherein coding the motion vector difference value comprises decoding the motion vector difference value, the method further comprising adding the motion vector difference value to a motion vector predictor determined according to the partial AMVP mode.

10. The method of claim 1, further comprising coding syntax information representative of the hybrid motion information coding mode for the current block.

11. The method of claim 1, wherein coding the current block comprises decoding the current block.

12. The method of claim 1, wherein coding the current block comprises encoding the current block.

13. A device for coding video data, the device comprising a video coder configured to code motion information for a current block of video data using a hybrid motion information coding mode, wherein to code the motion information, the video coder is configured to code a merge index syntax element of the motion information in a manner substantially conforming to a merge mode, and code at least one additional syntax element of the motion information in a manner substantially conforming to an advanced motion vector prediction (AMVP) mode, and wherein the video coder is configured to code the current block using the motion information.

14. The device of claim 13, wherein the hybrid motion information coding mode comprises a partial merge mode, wherein to code the at least one additional syntax element, the video coder is configured to code a reference index value that corresponds to an index value for a reference picture, and wherein to code the current block, the video coder is configured to code the current block relative to a portion of the reference picture.

15. The device of claim 14, wherein the video coder is further configured to determine a motion vector using the merge index syntax element, and scale the motion vector based on a picture order count (POC) value of the reference picture, and wherein to code the current block, the video coder is configured to code the current block using the scaled motion vector.

16. The device of claim 15, wherein to scale the motion vector, the video coder is configured to determine whether a difference between a POC value of a current picture including the current block and the POC value of the reference picture corresponding to the merge index can be expressed as a value 2ⁿ, wherein n is an integer, and when the difference can be expressed as the value 2ⁿ, the scaled motion vector as being equal to a product of the difference between the POC value of the current picture including the current block and the POC value of the reference picture corresponding to the merge index and the motion vector, wherein the product is bitwise right-shifted by n.

17. The device of claim 15, wherein to scale the motion vector, the video coder is configured to determine whether a difference between a POC value of a current picture including the current block and the POC value of the reference picture can be expressed as a value equal to m times a difference between the POC value of the current picture and a POC value of a reference picture corresponding to the merge index, wherein m is an integer, and when the difference can be expressed as the value m times the difference, calculate the scaled motion vector as being equal to m times the motion vector corresponding to the merge index.

18. The device of claim 13, wherein the hybrid motion information coding mode comprises a partial AMVP mode, and wherein to code the at least one additional syntax element, the video coder is configured to code a motion vector difference value.

19. The device of claim 18, wherein the video coder is further configured to determine a motion vector using the merge index syntax element, and wherein to code the current block, the video coder is configured to code the current block using the motion vector.

20. The device of claim 18, wherein the video coder comprises a video encoder, and wherein to code the motion vector difference value, the video encoder is configured to calculate the motion vector difference value based on a difference between a motion vector predictor determined according to the partial AMVP mode and a motion vector used to encode the current block.

21. The device of claim 18, wherein the video coder comprises a video decoder, wherein to code the motion vector difference value, the video decoder is configured to decode the motion vector difference value, and wherein the video decoder is further configured to add the motion vector difference value to a motion vector predictor determined according to the partial AMVP mode.

22. The device of claim 13, wherein the video coder is further configured to code syntax information representative of the hybrid motion information coding mode for the current block.

23. The device of claim 13, wherein the device comprises at least one of:
an integrated circuit;
a microprocessor; and
a wireless communication device that includes the video coder.

24. A device for coding video data, the device comprising:
means for coding motion information for a current block of video data using a hybrid motion information coding mode, wherein the means for coding the motion information comprises:
means for coding a merge index syntax element of the motion information in a manner substantially conforming to a merge mode; and
means for coding at least one additional syntax element of the motion information in a manner substantially conforming to an advanced motion vector prediction (AMVP) mode; and
means for coding the current block using the motion information.

25. The device of claim 24, wherein the hybrid motion information coding mode comprises a partial merge mode, wherein the means for coding the at least one additional syntax element comprises means for coding a reference index value that corresponds to an index value for a reference picture, and wherein the means for coding the current block comprises means for coding the current block relative to a portion of the reference picture.

26. The device of claim 25, further comprising:
means for determining a motion vector using the merge index syntax element; and
means for scaling the motion vector based on a picture order count (POC) value of the reference picture,
wherein the means for coding the current block comprises means for coding the current block using the scaled motion vector.

27. The device of claim 26, wherein the means for scaling comprise:
means for determining whether a difference between a POC value of a current picture including the current block and the POC value of the reference picture can be expressed as a value 2ⁿ, wherein n is an integer; and
means for calculating, when the difference can be expressed as the value 2ⁿ, the scaled motion vector as being equal to 2ⁿ and the motion vector corresponding to the merge index syntax element, and bitwise right-shifted by n.

28. The device of claim 26, wherein the means for scaling comprise:
means for determining whether a difference between a POC value of a current picture including the current block and the POC value of the reference picture can be expressed as a value equal to m times a difference between the POC value of the current picture and a POC value of a reference picture corresponding to the merge index, wherein m is an integer; and
means for calculating, when the difference can be expressed as the value m times the difference, the scaled motion vector as being equal to a product of the difference between the POC value of the current picture including the current block and the POC value of the reference picture corresponding to the merge index times the motion vector, wherein the product is bitwise right-shifted by n.

29. The device of claim 24, wherein the hybrid motion information coding mode comprises a partial AMVP mode, and wherein the means for coding the at least one additional syntax element comprises means for coding a motion vector difference value.

30. The device of claim 29, wherein the means for coding the current block comprises means for encoding the current block, and wherein the means for coding the motion vector difference value comprises means for calculating the motion vector difference value based on a difference between a motion vector predictor determined according to the partial AMVP mode and a motion vector used to encode the current block.

31. The device of claim 29, wherein the means for coding the current block comprises means for decoding the current block, and wherein the means for coding the motion vector difference value comprises means for decoding the motion vector difference value, further comprising means for adding the motion vector difference value to a motion vector predictor determined according to the partial AMVP mode.

32. A computer-readable storage medium having stored thereon instructions that, when executed, cause a processor of a device for coding video data to:
code motion information for a current block of video data using a hybrid motion information coding mode, wherein the instructions that cause the processor to code the motion information comprise instructions that cause the processor to:
code a merge index syntax element of the motion information in a manner substantially conforming to a merge mode; and
code at least one additional syntax element of the motion information in a manner substantially conforming to an advanced motion vector prediction (AMVP) mode; and
code the current block using the motion information.

33. The computer-readable storage medium of claim 32, wherein the hybrid motion information coding mode comprises a partial merge mode, wherein the instructions that cause the processor to code the at least one additional syntax element comprise instructions that cause the processor to code a reference index value that corresponds to an index value for a reference picture, and wherein the instructions that cause the processor to code the current block comprise instructions that cause the processor to code the current block relative to a portion of the reference picture.

34. The computer-readable storage medium of claim 33, further comprising instructions that cause the processor to:
determine a motion vector using the merge index syntax element; and
scale the motion vector based on a picture order count (POC) value of the reference picture,
wherein the instructions that cause the processor to code the current block comprise instructions that cause the processor to code the current block using the scaled motion vector.

35. The computer-readable storage medium of claim 34, wherein the instructions that cause the processor to scale the motion vector comprise instructions that cause the processor to:
determine whether a difference between a POC value of a current picture including the current block and the POC value of the reference picture can be expressed as a value 2ⁿ, wherein n is an integer; and
when the difference can be expressed as the value 2ⁿ, calculate the scaled motion vector as being equal to a product of the difference between the POC value of the current picture including the current block and the POC value of the reference picture corresponding to the merge index and the motion vector, wherein the product is bitwise right-shifted by n.

36. The computer-readable storage medium of claim 34, wherein the instructions that cause the processor to scale the motion vector comprise instructions that cause the processor to:
determine whether a difference between a POC value of a current picture including the current block and the POC value of the reference picture can be expressed as a value equal to m times a difference between the POC value of the current picture and a POC value of a reference picture corresponding to the merge index, wherein m is an integer; and
when the difference can be expressed as the value m times the difference, calculate the scaled motion vector as being equal to m times the motion vector corresponding to the merge index.

37. The computer-readable storage medium of claim 32, wherein the hybrid motion information coding mode comprises a partial AMVP mode, and wherein the instructions that cause the processor to code the at least one additional syntax element comprise instructions that cause the processor to code a motion vector difference value.

38. The computer-readable storage medium of claim 37, further comprising instructions that cause the processor to determine a motion vector using the merge index syntax element, wherein the instructions that cause the processor to code the current block comprise instructions that cause the processor to code the current block using the motion vector.
